(19) United States
(12) Patent Application Publication
(10) Pub. No.: US 2021/0383379 A1
(43) Pub. Date: Dec. 9, 2021

(54) TRANSACTION SYSTEM AND METHOD FOR REAL ESTATE AND CRYPTOCURRENCY USING BLOCKCHAIN TECHNOLOGY

(71) Applicant: YOUNG IL CHOI, Anyang-si Gyeonggi-do (KR)

(72) Inventor: YOUNG IL CHOI, Anyang-si Gyeonggi-do (KR)

(21) Appl. No.: 17/288,370

(22) PCT Filed: Aug. 28, 2019
(86) PCT No.: PCT/KR2019/011005

§ 371 Date: Apr. 23, 2021

(30) Foreign Application Priority Data
Oct. 26, 2018 (KR) 10-2018-0128686

(51) Int. Cl. G06Q 20/40; G06Q 50/16; G06F 16/27; G06Q 20/38

(52) U.S. Cl. CPC G06Q 20/401; G06Q 50/16; G06Q 2220/00; G06Q 20/389; G06F 16/27

(57) ABSTRACT

The present invention relates to a system and a method for issuing cryptocurrency by a request of a real estate transactor or transacting the issued cryptocurrency by a request of an owner of the real estate which has been transacted in a real estate transaction contracted by the real estate transactor and a licensed real estate agency. In the real estate transaction, the real estate transactor, who wants to receive a new loan from a financial institution to pay a part of a real estate transaction price to a seller or wants to accept an existing loan of the financial institution, and the real estate owner who has received a loan from the financial institution or wants to receive a new loan from the financial institution by providing the real estate as collateral for funding, abandon a part of a right for an actual value of the real estate to issue the cryptocurrency and refund the loan of the financial institution by a sale fund, thereby removing burden for financial expenses caused by the loan and protecting a right of an owner of the cryptocurrency.

### TECHNICAL FIELD

The present invention relates to a system which issues cryptocurrency in a real estate transaction blockchain system by a request of a real estate transactor or a real estate owner in a real estate transaction and automatically transacts the issued cryptocurrency by a smart contract block in a cryptocurrency transaction blockchain system, and more particularly, to a method and a system in which the real estate transaction blockchain system provides unique attribute information of the real estate for which the cryptocurrency is issued and real estate transaction information and the cryptocurrency transaction blockchain system provides cryptocurrency transaction information, thereby enabling the two systems to mutually share information in real time and to be integrally synchronized and operated.

### BACKGROUND ART

In general, real estate transaction is made under a condition that a real estate transactor receives a new loan from a financial institution to pay a part of a real estate transaction price or accepts an existing loan. At this time, a financial institution that makes a loan usually sets the first-ranked mortgage, and in this type of real estate transaction, financial costs occur, and if the real estate price falls or the situation of a real estate transactor or a real estate owner who has received the real estate loan is worsened, there is an inevitable reality of real estate auction.

In order to solve this problem, if an existing loan transaction method of the financial institution is changed to a method for issuing and transacting cryptocurrency of the present invention, the transaction price of the real estate and housing costs such as rent or monthly rent are lowered, and the disposable income of the real estate transactor or real estate owner is increased relatively by replacing the financial costs of the loan with cryptocurrency, thereby improving the economic conditions of a virtuous cycle structure.

As related prior arts, there are “real estate transaction system and method using real estate securities” (Korean Patent Application No. 10-2008-0014557, Feb. 18, 2008, Hyun-jin, Yoon), and a method of separately selling income certificates for real residence and investment by a “new homes system” published on Aug. 18, 2010 by Korea Real Estate Exchange. However, the real estate transaction blockchain system of the present invention has a difference from a method of transacting digital assets and actual real estates separately, in that a real estate owner creates a cryptocurrency transaction market by issuing cryptocurrency in exchange for giving up a part of the ownership, a cryptocurrency issuer may raise purpose funds, and a cryptocurrency buyer may invest in real estates with small amounts.

In addition, the conventional methods described above are a method of buying real estates from a company specializing in real estate liquidization and the like and separating certificates for real residence and investment, so that residents and investors have no real estate ownership. However, in the transaction system of the present invention, while the ownership for only a share corresponding to a cryptocurrency issuance rate is abandoned and the ownership of the real estate on a basic rate of self-residence or self-use share, which is a monopoly use beneficiary right as an exclusive right, is maintained, the real estate is used and an actual real estate may be sold. Therefore, in the case of the system of the present invention, since the issued cryptocurrency is transacted in a cryptocurrency transaction market and the actual real estate is transacted in an offline market, the system will be called a new method without requiring the intervention of a separate company specializing in real estate liquidization.

In real estate investment, in addition to actual real estate investment, there are a case of receiving profits by participating in real estate REITs and real estate fund products, and real estate P2P cloud funding in which individuals exchange funds peer-to-peer through the Internet by providing the real estate as collateral for funding. In such investment, costs of a separate operating company occur and in the case of the fund, a fund period is set, resulting in poor liquidity. In addition, the P2P cloud funding may cause false loans and bad loans of P2P companies or fall into a private placer that can embezzle funds, and when the P2P companies are bankrupt, there is a fatal risk for real estate investors.

Recently, real estate-related cryptocurrency is usually issued through initial coin offering (ICO) when a startup company publishes white papers and pre-mines, privately or publicly sells, or issued by initial exchange offering (IEO) by developing a minimum visible product (MVP). The cryptocurrency issued by the ICO or IEO has no actual value of currency like fiat currency at the time of issuance, so that the startup company artificially or arbitrarily calculates an exchange rate of fiat currency or coins and tokens, or gives the value by linking to real assets or services.

In addition, when many countries currently have the legal nature of cryptocurrency and the potential to be interpreted as security cryptocurrency for ICO, laws regulating securities are applied to comply with a security issuance procedure, and if not, guidelines for criminal and administrative sanctions are provided.

On the other hand, since the cryptocurrency of the present invention is money to which the actual value is already reflected, not a debt security that represents the right to payment to the issuer, and cryptocurrency classified as an equity security guaranteeing an equity share in an issuing company or an issuance foundation, or a right to underwrite new stocks, or an investment contract security attributable to the profit or loss of a joint business.

That is, the cryptocurrency of the present invention can be purchased only for fiat currency as digital money with an actual value of the real estate, and is not crytocurrency that is designed to be used as a payment means for other goods or services. However, the exchange of cryptocurrency within a platform to be presented by the present invention is not limited, and the cryptocurrency may serve as basic money which issues dependent cryptocurrency for payment or remittance of other goods or services as money that has a means of preserving the value of fiat currency. Of course, the dependent cryptocurrency will be used as a payment means when buying and selling the cryptocurrency of the present invention.

In order to implement this, in the present invention, an independent blockchain technology that applies a public blockchain technology such as Bitcoin and Ethereum of an open source and a hyperledger fabric technology of an open source of the IBM/Linux Foundation, which is one of a private blockchain technology.

### DISCLOSURE

### Technical Problem

In order to solve the problems in the related arts described above, an object of the present invention is to provide real estate transaction and cryptocurrency transaction blockchain system and method, in which a real estate transactor and a real estate owner create a transaction market by digitalizing an actual value of a real estate into cryptocurrency, the real estate transactor or the real estate owner reduces financial costs and protects a right of an owner of the cryptocurrency by refunding the loan of a financial institution with a selling fund of the cryptocurrency, and the real estate transactor and the real estate owner may easily raise a purpose fund by issuing the cryptocurrency for the ownership of all or a part of the real estate and creating the transaction market.

Another object of the present invention is to provide a system and method capable of efficiently grasping the real estate market and producing more rational and systematic real estate related information by closely analyzing real estate transaction information and cryptocurrency transaction information. For example, in the case of understanding or appraising a real estate price, the real estate price may be easily checked by a cryptocurrency price or transaction price, and may be used even in the transaction of actual real estates or in the loan of a financial institution if necessary. By checking the trend of cryptocurrency transaction by real estate, it is possible to reflect related data such as real estate preferences for each region, each size, and each use and changes in transaction prices to a real estate policy.

Yet another object of the present invention is to create a new type of market capable of increasing rigid liquidity and making selective investment and parallel or cross investment in stocks, bonds, and cryptocurrency by digitizing real assets to invest in the real estate with a small amount.

Still another object of the present invention is to lower the housing cost or using cost by ensuring a monopoly use beneficiary right, which is an exclusive right to allow the real estate to be directly lived or used with a small amount, when a real estate transactor and a real estate owner maintain the ownership of 35% of a basic rate of a self-residence or self-use share. Accordingly, since housing costs about rent/monthly rent or shop rental costs of renters will be transacted in consideration of the above basic rate of 35%, it is possible to reduce housing rental/monthly rental costs or shop rental costs.

### Technical Solution

According to an aspect of the present invention, there is provided a real estate transaction blockchain system, in which when an actual transaction of a real estate is concluded or a cryptocurrency issuance contract with a real estate owner is concluded, a real estate transactor, the real estate owner, and a licensed real estate agency for contract conclusion register a membership in a membership module by accessing a super node of the real estate transaction blockchain system, the real estate transactor transmits a multi-signature transaction without requiring decryption of a seller and a buyer to a transaction container and the real estate owner transmits a single-signature transaction without requiring decryption of a real estate owner for which the cryptocurrency is issued, and then the real estate transactor or the real estate owner requests the distributed issuance of the transaction. At the same time, the licensed real estate agency for contract conclusion requests the generation of a smart contract block (hereinafter, referred to as a smart block) or a cryptocurrency issuance block (hereinafter, referred to as a cryptocurrency block) to the RFY code module by using a public key of the agency and a public key of the real estate transactor or the real estate owner.

Here, the membership module generates each address/private key/public key when registering the membership. The transaction container distributes and issues, to each node of multiple participating licensed real estate agencies, the transaction without requiring decryption multi-signed by the public key of the real estate transactor and the transaction without requiring decryption single-signed by the public key of the real estate owner.

Here, the RFY code module checks the transactions in the transaction container to generate a hash function smart block or cryptocurrency block by using a secret key and a common public key of the super node of the real estate transaction blockchain system and transmit the generated smart block or cryptocurrency block to the real estate transactor, the real estate owner, and each node of the licensed real estate agency for contract conclusion, and the real estate transactor and the licensed real estate agency for contract conclusion complete the real estate transaction. Then, the real estate owner and the licensed real estate agency for contract conclusion check the cryptocurrency block and the licensed real estate agency for contract conclusion transmits the cryptocurrency block to the transaction container of the super node of the real estate transaction blockchain system. In this case, the transaction container distributes and issues the hash function smart block and the hash function cryptocurrency block to each node terminal of the multiple participating licensed real estate agencies for transaction verification.

At this time, the hash function of each block is arbitrarily assigned from the RFY code module, and the common public key generated from the system secret key is transmitted and distributed to the block of the hash function.

Here, a consensus algorithm of the system of the present invention uses a unique No-Objection method in accordance with compliance of the present invention, unlike general blockchain technologies such as proof-of-work (POW) and proof-of-stake (POS/DPOS), generates the smart block and the cryptocurrency block for the real estate transaction with a hash function, and each hash value is assigned with a random number in the RFY code block of each system when each block is generated for quick processing.

At this time, each node of the multiple participating licensed real estate agencies compares and verifies the multi-signature transaction of the real estate transactor distributed at the time of concluding the contract and the single-signature transaction of the real estate owner, and then chains the blocks to be recorded in the distributed ledger. After the transaction verification at each node, if the blocks are chained to be recorded in the distributed ledger, a trust registration is completed for each block, and the RFY code block module issues cryptocurrency according to a contract condition of issuing the cryptocurrency based on the transaction price of the real estate or the real estate market price calculated in consultation by the real estate owner and the licensed real estate agency for contract conclusion and deposits the issued cryptocurrency in a trust account.

Here, the real estate price calculated by consultation means a current value of the real estate obtained by the consent of the real estate owner by referring to an actual transaction price or similar real estate transaction price for the corresponding real estate by a licensed real estate agency for contract conclusion in the transaction or one selected from the multiple participating licensed real estate agencies, a set amount of a collateral security by a financial institution or an appraised value of land or individual house price by a government agency, an appraised value, a court auction price, and the like.

The RFY code module requests the generation of a smart contract block to be used for a cryptocurrency transaction to the cryptocurrency transaction blockchain system of the present invention in order to transact the issued cryptocurrency.

In order to operate the above system, the real estate transaction blockchain system of the present invention may be implemented by including the super node consisting of the membership module, the RFY code module, the P2P protocol, the distributed ledger DB, and the transaction container, each node terminal such as the real estate transactor, the real estate owner, the licensed real estate agency for contract conclusion, the multiple participating licensed real estate agencies, the trust company, etc., and the super node of the cryptocurrency transaction blockchain system.

According to another aspect of the present invention, as a technical matter for implementing the present invention, there is provided a cryptocurrency transaction blockchain system which is connected to the real estate transaction blockchain system, and when a smart contract block of a hash function for real estate-specific cryptocurrency transaction is generated, the cryptocurrency block in the transaction container of the super node of the cryptocurrency transaction blockchain system is returned to the transaction container of the super node of the real estate transaction blockchain system again.

At this time, the returned cryptocurrency block is distributed and issued to the real estate transactor, the real estate owner, the licensed real estate agency for contract conclusion, and each node of the multiple participating licensed real estate agencies, and chained to the distributed ledger DB of the real estate transaction blockchain system, so that each node knows that a cryptocurrency transaction smart contract block that can transact cryptocurrency has been generated. From this, the real estate transactor and the real estate owner are converted into a cryptocurrency transactor.

Here, when a cryptocurrency transaction is made in the cryptocurrency smart contract block, the transaction is automatically transmitted to the transaction container of the super node of the cryptocurrency transaction blockchain system and the transaction container of the super node of the real estate transaction blockchain system. At this time, the transaction container of the super node of the cryptocurrency transaction blockchain system is distributed and issued to the cryptocurrency transactor, the licensed real estate agency for transaction intercession and each node of the multiple participating licensed real estate agencies.

When the RFY code module of the super node of the cryptocurrency transaction blockchain system collects a certain amount of transactions again and generates a cryptocurrency transaction block of a hash function, and transmits the generated cryptocurrency transaction block to the transaction container of the super node of the cryptocurrency transaction blockchain system and the transaction container of the super node of the real estate transaction blockchain system for transaction verification and distributed ledger recording, the transaction container of the super node of the cryptocurrency transaction blockchain system is distributed and issued to the cryptocurrency transactor, the licensed real estate agency for contract conclusion, the licensed real estate agency for transaction intercession, and each node of the multiple participating licensed real estate agencies, and each node verifies the transaction and chains the cryptocurrency transaction block to be recorded in the distributed ledger DB.

The RFY code module of the super node of the real estate transaction blockchain system verifies the cryptocurrency transaction and the cryptocurrency transaction block pending in the transaction container and then chains the block to the distributed ledger DB to be recorded in the distributed ledger, and then changes in the cryptocurrency of each address in the real estate transaction blockchain system are updated. At this time, in order to maintain security, even if there is no transaction after a certain period of time, a cryptocurrency transaction block may be generated and distributed and issued to each node.

The exchange of cryptocurrency is made in the real estate transaction blockchain system, fiat currency for cryptocurrency transactions is deposited and withdrawn to a trust account using a private key, and when a trust company, etc., transmits fiat currency deposit and withdrawal information to the transaction container of the super node of the cryptocurrency transaction blockchain system, changes in the cryptocurrency transaction blockchain system are synchronized in real time, and the state information of fiat currency is updated in real time in the name of the public key at the party's address.

In this case, a personal electronic wallet function in a general blockchain technology is not used in the system of the present invention. Therefore, the private key generated in the membership module is used for digital signatures and information inquiry about the person if necessary, and is limitedly used in trust accounts when depositing and withdrawing fiat currency to each address of the cryptocurrency transaction blockchain system or when transferring to a domestic account, to be used as an identification key so that the transaction details of cryptocurrency and fiat currency are indicated at each address of the cryptocurrency transaction blockchain system in the name of the public key.

Here, the limited use of the private key means that only the private key cannot be used if fiat currency is transferred or withdrawn outside the country, and is to be processed by a reinforced separate procedure. Export of cryptocurrency to foreign countries will not be made unless there is a special occasion due to the nature of the cryptocurrency of the present invention.

As such, the total amount of fiat currency and the total amount of cryptocurrency in the trust account managed by the trust company, and the total amount of the fiat currency and the total amount of cryptocurrency recorded in the distributed ledger DB every time a cryptocurrency transaction in the cryptocurrency transaction blockchain system are settled at the same number, and the total amount of cryptocurrency indicated in each address of the real estate transaction blockchain system will always be the same at a certain time point.

To this end, the cryptocurrency blockchain system of the present invention may be implemented by including the super node consisting of the membership module, the RFY code module, the P2P protocol, the distributed ledger DB, and the transaction container, each node terminal such as the cryptocurrency transactor (that is, means the real estate transactor and the real estate owner), the licensed real estate agency for transaction intercession, the multiple participating licensed real estate agencies, the trust company, etc., and the super node of the real state transaction blockchain system.

As described above, one feature of the present invention is that the real estate transaction blockchain system provides unique attribute information of the real estate and real estate transaction information for cryptocurrency, and the cryptocurrency transaction blockchain system provides cryptocurrency transaction information to mutually share the information and be linked, so that the two systems of the present invention operate as one integrated system.

Another feature of the present invention is that a secret key of the super node of each system and a system public key generated from the secret key are used for inquiring and retrieving information details of a block, which are managed by the membership module.

In addition, the cryptocurrency transaction intercession is performed by the licensed real estate agency for contract conclusion or the multiple participating licensed real estate agencies (i.e. all participating licensed real estate agencies), so that all participating licensed real estate agencies play a role as the market maker of the network of the present invention.

In order to create an efficient and sound market for the system of the present invention, when the cryptocurrency is issued by a licensed real estate agency for contract conclusion that acts as a market maker, the cryptocurrency issuance is regarded as mining of public blockchain technology and compensation is made in its own way. In this system, the compensation is made to the licensed real estate agency for contract conclusion issuing the cryptocurrency as a miner. The compensation is paid not at the time of issuance, but at the time of transaction, as compensation for a certain portion of the transaction fee to the licensed real estate agency for contract conclusion issuing the cryptocurrency. Accordingly, the operator of the system of the present invention, the licensed real estate agency for contract conclusion and the licensed real estate agency for transaction intercession share the transaction fee.

At this time, the reason for not paying the compensation at the time of issuance is to prevent the indiscriminate overpopulation of cryptocurrencies and induce the issuance of high-quality cryptocurrencies that may be transacted in the market to carefully approach the market to ensure market reliability, thereby activating the network according to the system of the present invention and fostering a healthy market.

### Advantageous Effects

According to the system and method of the present invention, when the real estate is transacted or when the real estate owner issues cryptocurrency and refunds the loan of a financial institution with the selling funds, a significant reduction in the interest burden on mortgage loans will occur. For example, according to data from the Bank of Korea, only the balance of mortgage loans at the end of 2017 is 578 trillion 310 billion won, and if an annual interest rate of 3.5% is applied thereto, an annual loan interest of about 2,240 trillion won is estimated.

In addition, by using the system of the present invention, it is possible to transact cryptocurrency even with a small amount to enable diversified investment in an actual real estate and parallel investment with stocks or bonds or cross-investment, so that an opportunity to make a selective investment depending on an investment condition is provided to mitigate an investment risk or to expect a return on portfolio investment.

In addition, the system of the present invention improves the liquidity through cryptocurrency (digitalization) of an actual value of the real estate and provides a means of preserving the value of fiat currency, and reduces real estate transaction costs and real estate investment costs to relatively increase disposable income, thereby contributing to economic and social stability in the real estate transaction market.

In addition, the system of the present invention can provide more systematic investment information by closely analyzing the transaction trend of cryptocurrency, and develop complex financial derivatives of a real estate and finance in a cryptocurrency version, thereby promoting various fields, such as analysis and evaluation of the actual value of cryptocurrency related to the cryptocurrency economy generated in the system of the present invention, investment consulting, and asset management.

### DESCRIPTION OF DRAWINGS

FIG. 1 is an overall representative diagram illustrating a real estate transaction and cryptocurrency transaction system based on a blockchain technology according to an embodiment of the present invention.

FIG. 2 is a block diagram of a real estate transaction system based on a blockchain technology according to an embodiment of the present invention.

FIG. 3 is a block diagram of a cryptocurrency transaction system based on a blockchain technology according to an embodiment of the present invention.

FIG. 4 is an exemplary diagram of an initial block and type-specific transactions in the real estate transaction system of the present invention.

FIG. 5 is an exemplary diagram of a smart contract block and a cryptocurrency transaction block in the cryptocurrency transaction system of the present invention.

FIG. 6 is an exemplary diagram of a block identification number used in the system of the present invention.

FIG. 7 is an exemplary diagram of state balances of cryptocurrency and fiat currency in the system of the present invention.

FIG. 8 is a flowchart of an operation of a blockchain system between participants of the present invention.

### BEST MODES

The present invention may have various modifications and various embodiments and specific embodiments will be illustrated in the drawings and described in detail in the detailed description. However, the present invention is not limited to specific embodiments, and it should be understood that the present invention covers all the modifications, equivalents and replacements within the spirit and technical scope of the present invention.

In describing the present invention, a detailed description of related known technologies will be omitted if it is determined that it unnecessarily makes the gist of the present invention unclear. In addition, numeral figures (e.g., first, second, and the like) used during describing the specification are just identification symbols for distinguishing one component from the other component. Further, in the present specification, if it is described that one component is “connected to” or “accesses” the other component, it will be understood that the one component may be directly connected to or directly access the other component, but unless otherwise described to the contrary, the component may be “connected” or “accessed” via another component therebetween. Throughout this specification, when a certain part “comprises” a certain component, unless otherwise described to the contrary, it is meant that another component may be further included, rather than excluding another component.

Hereinafter, a configuration and an operation of an embodiment of the present invention will be described in detail with reference to the accompanying drawings.

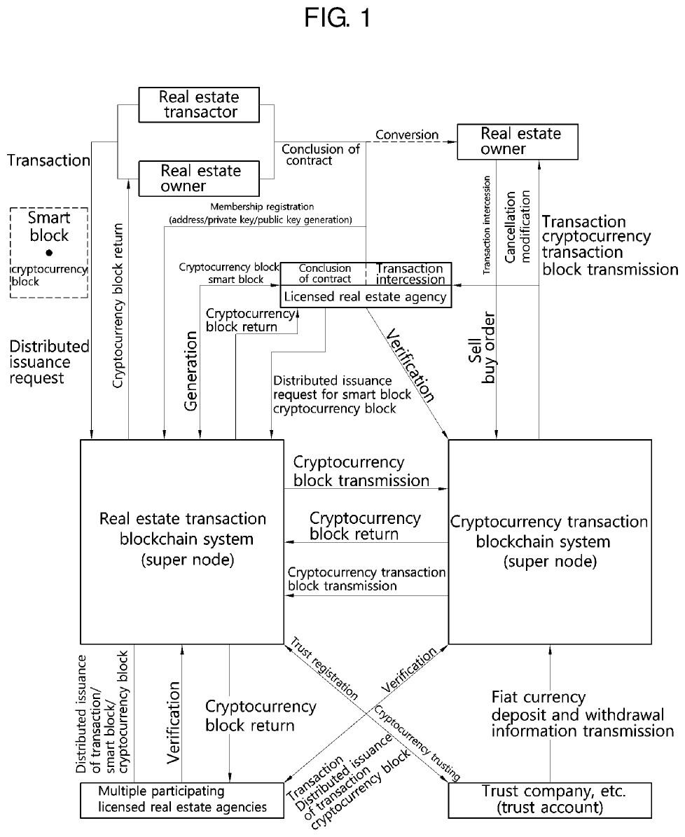

Referring to FIGS. 1 to 3, in the present invention, two systems of a real estate transaction blockchain system and a cryptocurrency transaction blockchain system are integrated to operate as one system as illustrated in FIGS. 1 to 3.

In the real estate transaction blockchain system according to the embodiment of the present invention, a super node 100 may be implemented by including a membership module 110, an RFY code module 120, a distributed ledger DB 130, a transaction container 140, and a P2P protocol 150.

In the cryptocurrency transaction blockchain system according to the embodiment of the present invention, a super node 200 may be implemented by including a membership module 210, an RFY code module 220, a distributed ledger DB 230, a transaction container 240, and a P2P protocol 250.

In addition, the super node of each system is connected with a licensed real estate agency terminal 300 for contract conclusion or transaction intercession, a real estate transactor terminal 400, a real estate owner terminal 500, a cryptocurrency transactor terminal 600, multiple participating licensed real estate agency terminals 700, and a terminal 800 such as a trust company, etc.

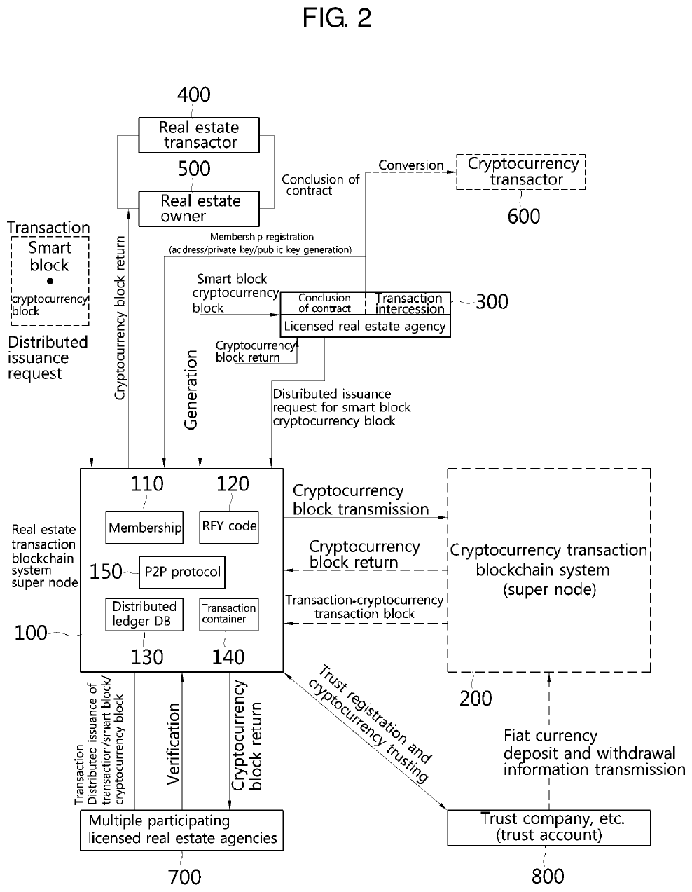

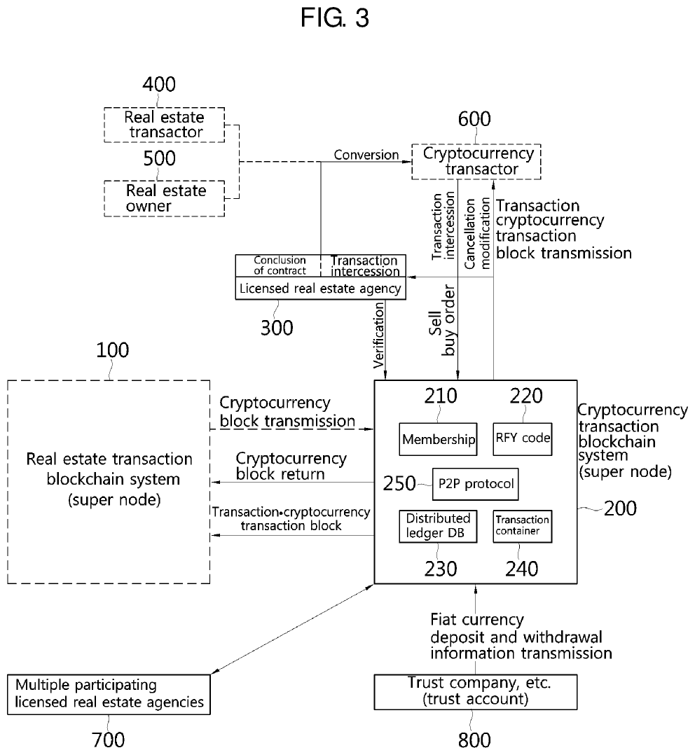

The real estate transaction blockchain system of FIG. 2 and the cryptocurrency transaction blockchain system of FIG. 3 are externally private blockchain systems, but internally strong public blockchain systems, and the two systems are integrated to operate as one hybrid system.

First, referring to FIG. 2, in a block diagram of the real estate transaction blockchain system, when the real estate transactor 400 or the real estate owner 500 concludes a contract for an actual transaction of the real estate and cryptocurrency issuance by intermediation of the licensed real estate agency terminal 300 for contract conclusion, the real estate transactor 400 or the real estate owner 500 issues cryptocurrency according to a cryptocurrency issuance amount (that is, a cryptocurrency issuance amount according to a cryptocurrency issuance rate for a real estate transaction price or real estate market price and the determination of a selling price per unit of cryptocurrency (in the present invention, arbitrarily expressed as RFY)).

In the present specification, for convenience and concentration of explanation, it is assumed that a basic rate of self-residence or self-use share, which is an exclusive right for the real estate set according to compliance according to the system of the present invention, is 35%. Of course, it is obvious that such a basic rate may vary depending on a system design.

As described above, in a case where the basic rate of 35% is applied to the system of the present invention, if the self-residence or self-use share is lowered to less than 35%, a system design may be made so that a cryptocurrency owner having at least twice of the self-residence or self-use share executes a buying offering right or a third-party sell offering right. Therefore, in accordance with this, the resident or user needs to ensure stability in residence or use by maintaining preferably the basic rate of 35% at the cryptocurrency transaction trend. In addition, according to the system design, when a renter acquires cryptocurrency, the renter offers the priority buying right when disposing of the real estate, so that it is possible to defend against reaching the basic rate of 35% by buying a cryptocurrency share that is less than 35% of the basic rate. At this time, the basic rate of self-resident and self-use shares includes a

When the real estate transactor 400 or the real estate owner 500 and the licensed real estate agency 300 for contract conclusion access the super node 100 of the real estate transaction blockchain system and input personal information such as a name, a password, an email, a phone number and a social security number of each user in the membership module 110, the membership module 110 may generate an address, a private key, and a public key of each member.

Since all licensed real estate agencies who have participated in the system of the present invention register the membership upon participation, the personal information is input and the address, the private key, and the public key of each member are already generated. At this time, the generated address corresponds to a bank account number and is a string of functions recognized as numbers and letters, the private key and the public key are also strings of a hash function, and the public key is used as a depositor name of each address to protect the personal information.

In the real estate transaction and cryptocurrency transaction blockchain system of the present invention, in principle, a personal electronic wallet function used in a blockchain system such as Bitcoin or Ethereum is not used. Accordingly, the private key is used for digital signature and information inquiry and search if necessary, but in a network with the cryptocurrency transaction blockchain system of FIG. 3, the private key may be limitedly used at the time of cryptocurrency transaction and fiat currency deposit and withdrawal. In addition, the private key may be used as an identification key for updating and recording a change history in cryptocurrency and fiat currency at each address with a public key name in real time when the transaction is automatically performed in the smart contract block of the cryptocurrency transaction blockchain system or when the fiat currency is deposited and withdrawn. Accordingly, the owner of cryptocurrency and fiat currency recorded in the corresponding address may be indicated with the public key to ensure the anonymity of personal information.

After registering the membership in the membership module 110, the real estate transactor 400 transmits a multi-signature transaction without requiring decryption signed with a public key of a seller and a buyer, and the real estate owner 500 transmits a single-signature transaction without requiring decryption signed by a public key of the owner to the transaction container 140 of the super node 100 of the real estate transaction blockchain system to request the distributed issuance of the multi-signature transaction or the single-signature transaction. At the same time, the licensed real estate agency 300 for contract conclusion requests the generation of a smart contract block (hereinafter, referred to as a smart block) using the public key of the agency and the public key of the real estate transactor or the public key of the real estate owner or a cryptocurrency issuance block (hereinafter, referred to as a cryptocurrency block) of the real estate owner to the RFY code module 120.

Accordingly, the transaction container 140 distributes and issues the transaction of the real estate transactor 400 or the real estate owner 500 to each node of the multiple participating licensed real estate agencies 700.

Meanwhile, the RFY code module 120 checks the multi-signature transaction of the real estate transactor or the single-signature transaction of the real estate owner while pending in the transaction container 140 to generate a hash function smart block of the real estate transactor or a hash function cryptocurrency block of the real estate owner by using a common public key generated from a secret key of the super node 100 of the real estate transaction blockchain system and transmit the generated smart block or cryptocurrency block to the real estate transactor 400 or the real estate owner 500 and the licensed real estate agency 300 for contract conclusion. In this case, the smart block may be a computer code that requests execution of a contract, not a legal document written in a natural language that has legal binding power among two references, such as the concept of a Ricardian contract of Ian Grid.

Upon completion of the transaction, the licensed real estate agency 300 for contract conclusion transmits, to the transaction container 140 of the super node 100 of the real estate transaction blockchain system, the multi-signature smart blocks of the real estate transactor and the licensed real estate agency for contract conclusion or multi-signature cryptocurrency blocks of the real estate owner and the licensed real estate agency for contract conclusion to request the distributed issuance for transaction verification to each node of the multiple participating licensed real estate agencies 700. In this case, the multi-signature is made by each public key and means a signature for confirming that there is no problem in contents of the smart block or the cryptocurrency block of the hash function confirmed by the common public key.

Accordingly, the transaction container 140 distributes and issues the hash function smart block or the hash function cryptocurrency block to each node of the multiple participating licensed real estate agencies 700 for transaction verification.

At this time, the reason why the distributed issuance of the multi-signature or single-signature transaction is different from the distributed issuance of the hash function smart block and the hash function cryptocurrency block is that in order to maintain the integrity of the transaction, it is necessary for the real estate transactor or the real estate owner and the licensed real estate agency for contract conclusion to proceed the contract separately or overlapping.

In addition, in the embodiment of the present invention, a consensus algorithm for verification does not follow general proof-of-work (POW), proof-of-stake (POS), practical Byzantine failure tolerance (PBFT), RAFT, PAXOS, etc., but uses a No-Objection method which is an independent method defined in the system of the present invention. Here, the No-Objection method refers to a method of comparing the contents of the multi-signature or single-signature transaction distributed and issued in the transaction container 140 with the contents of the hash function smart block or the hash function cryptocurrency block generated in the RFY code module 120 and distributed and issued in the transaction container 140. In the case of the real estate transaction, there may be a case where a multi-signature transaction distributed and issued at the time of the conclusion of the contract is pending in the transaction container 140 of the super node 100 and the transaction container of each node of the multiple participating licensed real estate agencies for about 1 month until the transaction is completed and the smart block is distributed and issued. At this time, each node of the multiple participating licensed real estate agencies 700 performs the transaction verification, and in the case of the multi-signature transaction, an objection is actually made by canceling the contract by the contracting parties, and in this case, it is impossible to proceed to the distributed issuance of the smart block. Accordingly, when the transaction is completed and the smart block of the hash function is distributed in the transaction container 140, the actual transaction corresponds to the conversion into the No-Objection state to be blockchained to a distributed ledger DB in each node, so that this method corresponds to the No-Objection method in the present invention.

The real estate owner 500 selects one (may be a licensed real estate agency that has concluded a real estate transaction contract) of all the participating licensed real estate agencies and concludes a cryptocurrency issuance contract. The real estate owner 500 and the licensed real estate agency 300 for contract conclusion input personal information and register the membership by accessing the membership module 110 of the super node 100 of the real estate transaction blockchain system to generate an address, a private key, and a public key. Thereafter, when the real estate owner requests a distributed issuance of a single-signature transaction without requiring decryption to the transaction container 140 of the super node 100, the transaction container 140 distributes and issues the single-signature transaction to each node of the multiple participating licensed real estate agencies 700. The licensed real estate agency 700 for contract conclusion requests the generation of the cryptocurrency block to the RFY code module 120 of the super node 100.

Accordingly, when the RFY code module 120 generates a hash function cryptocurrency block which may be confirmed by a common public key of the super node 100 to transmit the generated hash function cryptocurrency block to the real estate owner 500 and the licensed real estate agency 300 for contract conclusion, the real estate owner and the licensed real estate agency for contract conclusion confirm the hash function cryptocurrency block and make a multi-signature with each public key. Thereafter, when the licensed real estate agency for contract conclusion transmits the cryptocurrency block to the transaction container 140 to request the transaction verification, the transaction container 140 distributes and issues the hash function cryptocurrency block for verification to each node of the multiple participating licensed real estate agencies 700.

Further, each node verifies the cryptocurrency block with the pre-distributed/issued single-signature transaction of the real estate owner before receiving the distributed issuance of the cryptocurrency block, a licensed real estate agency that contracted the previous real estate transaction of the real estate owner may have an objection. Even in this case, since the distributing and issuing of the cryptocurrency block may not be performed, the cryptocurrency block is distributed and issued and blockchained to the distributed ledger DB in the No-Objection state after a certain amount of time. Since there is no value transfer during the generating and the distributing and issuing of the cryptocurrency block, it is possible to maintain the integrity in the reliability of transaction verification. If the block is chained to the distributed ledger DB in the No-Objection state, the transaction pending in the transaction container of each node lapses.

Thereafter, when the licensed real estate agency 300 for contract conclusion and the real estate transactor 400 or the real estate owner 500 conclude a cryptocurrency trust storage agreement with a system operator of the present invention and the system operator of the present invention completes a trust registration for the issuance of cryptocurrency with a trust company, etc. that participated in this system, the RFY code module 120 issues cryptocurrency according to the conditions of a cryptocurrency block (in this case, the smart block is converted into a cryptocurrency block) to entrust the cryptocurrency to a trust company 800 and the like and transmits the cryptocurrency block to the transaction container 240 of the super node 200 of the cryptocurrency transaction blockchain system of FIG. 3 to request the generation of a smart contract block for cryptocurrency.

The RFY code module 220 of the super node 200 of the cryptocurrency transaction blockchain system of FIG. 3 searches for a cryptocurrency issuance condition of the cryptocurrency block transmitted from the real estate transaction blockchain system of the present invention to generate a cryptocurrency transaction smart contract block and starts to perform a transaction. When the RFY code module 220 generates the cryptocurrency transaction smart contract block and returns the cryptocurrency block transmitted from the super node 100 of the real estate transaction blockchain system to the transaction container 140 of the corresponding super node 100, the cryptocurrency block is distributed and issued to the real estate transactor 400 and the real estate owner 500, the licensed real estate agency 300 for contract conclusion, and the multiple participating licensed real estate agencies 700 to be chained to the distributed ledger DB, and each node determines that the cryptocurrency transaction smart contract block has been generated.

From this time, the real estate transactor and the real estate owner are converted into a cryptocurrency transactor, and the cryptocurrency transactor 600 inputs personal information to the membership module 210 of the super node 200 of the cryptocurrency transaction blockchain system of the present invention and generates an address, a private key, and a public key to transact the cryptocurrency.

When the cryptocurrency transactor deposits fiat currency for a buying fund of the cryptocurrency into a trust account of a trust company, etc., the cryptocurrency transactor uses a private key, and a deposit amount is recorded in each address in the name of a public key linked to the private key. In the case of the real estate transactor and the real estate owner, when the cryptocurrency block is returned, the transaction is converted to the cryptocurrency transaction 600, and then all real estate-specific cryptocurrencies as well as self-issued cryptocurrency may be transacted. To this end, pre-generated address, private key, and public key are used, and there is no need to register a separate membership.

When the cryptocurrency transactor makes a sell/buy order for cryptocurrency by using one (here, the agency of the used public key is a licensed real estate agency for cryptocurrency transaction intercession) of public keys of all participating licensed real estate agencies and the transaction is automatically concluded in the cryptocurrency smart contract block, the cryptocurrency transactor transmits the cryptocurrency transaction to the transaction container 240 of the super node 200 of the cryptocurrency transaction blockchain system of FIG. 3 and the transaction container 140 of the super node 100 of the real estate transaction blockchain system of FIG. 2. At this time, the transaction container 240 of the super node 200 of the cryptocurrency transaction blockchain system distributes and issues the cryptocurrency transaction to the licensed real state agency 300 for transaction intercession, the cryptocurrency transactor 600, and each node of the multiple participating licensed real estate agencies 700.

The distributed and issued transaction is searched and pending in the transaction container of each node. Thereafter, when a certain amount of transactions is collected to generate a hash function cryptocurrency transaction block and the generated hash function cryptocurrency transaction block is distributed and issued to each node, the generated hash function cryptocurrency transaction block is compared with the cryptocurrency transaction pending in the transaction container and blockchained to the distributed ledger DB. Even if the transaction is not established within a certain period of time, a cryptocurrency transaction block is automatically generated and transmitted to the transaction container 240 of the super node 200 of the cryptocurrency transaction blockchain system, and distributed and issued to each node to be blockchained to the distributed ledger DB. In addition, even if a small amount of transactions occurs within a certain period of time, a cryptocurrency transaction block is automatically generated, and distributed and issued to each node to be blockchained to the distributed ledger DB. As a result, the cryptocurrency transaction pending in each transaction container is recorded in the distributed ledger DB and then immediately lapses.

In the system of the present invention, a change history in cryptocurrency at the address of the cryptocurrency owner for each real estate is synchronized and updated in real time, and the information is provided in real time to all the participating licensed real estate agencies 300 and 700 and the cryptocurrency transactor 600 serving as a market maker.

The real estate transaction blockchain system of the present invention provides unique attribute information for each real estate for cryptocurrency and real estate transaction information, and the cryptocurrency transaction blockchain system of the present invention provides detailed information related to the cryptocurrency transaction such as a owning history and a market price for each real estate and for each cryptocurrency address, thereby enabling the two systems to mutually share the information and to be integrally operated as one system.

When the cryptocurrency transaction is made, a transaction fee is charged to the cryptocurrency transactor, but among the transaction fees, a predetermined fee is paid as compensation to a licensed real estate agency for contract conclusion of cryptocurrency issuance and a licensed real estate agency participating in interceding the cryptocurrency transaction. In particular, the licensed real estate agency 300 participating in the cryptocurrency issuance is compensated by considering the issuance of cryptocurrency as mining. However, a part of the transaction fee is paid every cryptocurrency transaction without compensation when issuing. This is because the indiscriminate issuance of cryptocurrency is prevented to induce the issuance of high-quality cryptocurrency and promote transactions, thereby fostering and maintaining a healthy market.

In the system of the present invention, even if the cryptocurrency transactor makes a direct transaction without the intercession of a participating licensed real estate agency who is a market maker, the cryptocurrency transactor sets a condition to pay a transaction fee for maintaining the system of the present invention to actively receive an advice of the market marker, thereby providing conditions to mitigate or avoid the risk for investors.

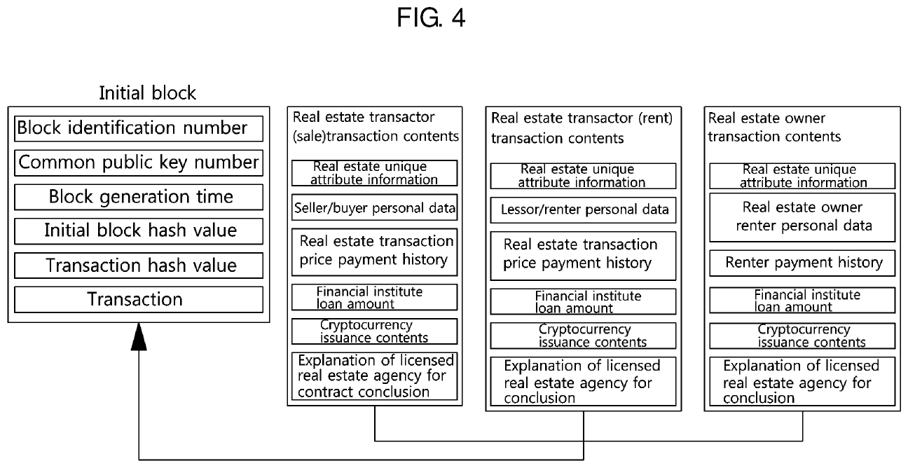

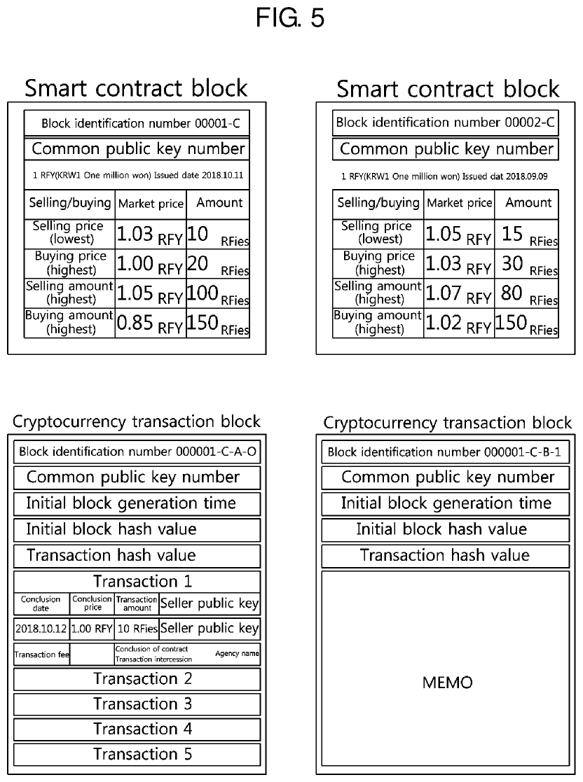

FIGS. 4 and 5 are diagrams illustrating an initiation block and examples of type-specific transactions, and a smart contract block and a cryptocurrency transaction block in a cryptocurrency transaction system. The smart block of the real estate transactor and the cryptocurrency block of the real estate owner generated in the real estate transaction blockchain system of FIG. 2, and the cryptocurrency smart contract block, the cryptocurrency transaction initial block, and a cryptocurrency transaction block of the real estate owner generated after the initial block of the cryptocurrency transaction blockchain system of FIG. 3 are illustrated when there is a transaction and when the transaction is not established and generated for each real estate.

In FIG. 4, a cryptocurrency issuance transaction has a key condition for issuing cryptocurrency, and the contents thereof are as follows. At this time, a cryptocurrency trust storage agreement is concluded between the cryptocurrency issuer and the system operator of the present invention, and the cryptocurrency is trusted to a trust company and the like in the name of the system operator of the present invention, and the transaction is initiated at the same time.

First, the basic rate of the self-residence or self-use share which is the exclusive monopoly use beneficiary right for the cryptocurrency-issued real estate is set, wherein the basic rate is 35%, and when the basic rate of the real estate transaction price or the real estate market price is maintained less than 35%, the cryptocurrency owner of at least twice of the self-residence or self-use share may execute a buying offering right or a third party selling offering right. In other words, in the present system, when the basic rate of the self-residence or self-use share is 35% or more, the cryptocurrency owner has the monopoly use beneficiary right which is the exclusive right for the corresponding cryptocurrency-issued real estate, but when the basic rate of the self-residence or self-use share is less than 35%, the cryptocurrency owner may be threatened by the own exclusive right.

Second, the owner with 35% or more of the basic rate of the self-residence or self-use share needs to pay all costs, such as taxes on the entire real estate for the monopoly use beneficiary right, which is the exclusive right.

Third, in the case of issuing cryptocurrency for the entire real estate, profits and costs are shared and commonly burdened in proportion to the share. Fourth, an auction method may be used if necessary when disposing of real estates.

Fifth, the renter owning the cryptocurrency uses the priority buying offering right when disposing of the real estate, and when a lessor fails to maintain the basic rate, the lessor may buy the cryptocurrency of the deficit by subrogating the renter and defend 35% of the basic rate.

Sixth, the priority of rights for this is in order of 1) a person with a basic rate of 35% or more of the self-residence or self-use share, 2) a cryptocurrency owner of at least twice, 3) a largest owner of cryptocurrency, 4) a longest owner of cryptocurrency, and 5) a renter owning the cryptocurrency.

According to the above-described business model, the following effects may be achieved.

First, in the case of a real estate owner who own a real estate, within the limit of owning (maintaining) at least 35% of the basic rate of self-residence or self-use share, which is the monopoly and exclusive right for the corresponding real estate, it is possible to issue cryptocurrency corresponding to the real estate transaction price or the market price equivalent to the remaining rate (65% or less), thereby allowing investors to buy the cryptocurrency issued as such. According to this, in the related art, investors were forced to make real estate investments in the form of using loans from financial institutions or buying a real estate with rent or monthly rent in the name of gap investments with large funds. However, according to the present system, even with a small investment, it is possible to invest in the corresponding real estate by buying a part of the cryptocurrency issued based on the corresponding real estate for a real estate with favorable factors in the future. In other words, in the related art, only investments in the entire real estate (i.e. buying of the real estate) were enabled, whereas according to the present system, a small amount of investment (i.e., buying of cryptocurrency) in a part of the corresponding real estate is enabled. Therefore, the real estate owner may raise funds by selling the issued cryptocurrency without departing from the own monopoly and exclusive right and uses preferentially these funds to refund the mortgage loans received from the financial institution, etc., thereby protecting the rights of the cryptocurrency owner.

In addition, a real estate transactor (i.e. a person who is willing to buy a real estate) may buy a real estate with only funds corresponding to 35% of the share basic rate that may own the monopoly exclusive rights, not the total value of the real estate to be bought and may collect funds corresponding to the remaining share rate through issuance of cryptocurrency. For example, in the case of a real estate with favorable factors in the future, there may be other investors who want to invest in advance in consideration of future market rise. According to the present system, when buying the real estate through issuance of cryptocurrency and the transaction, it will be able to solve the lack of funds. For example, a lotting-out right owner who has the right to lotting-out apartments will be able to buy the real estate in the form of sharing profits with other investors through the issuance of cryptocurrency for the premium that will have in the future. Accordingly, according to the present system, in buying an apartment to be lived, the corresponding apartment may be bought even if there is no total fund corresponding to the selling price of the corresponding apartment, and thus, there is an advantage of greatly contributing even to the stability of housing for the general public.

In addition, even in terms of the licensed real estate agency that executes the contract conclusion or cryptocurrency transaction, by actively participating in the issuance of cryptocurrency for the real estate, which may be favorable, it is possible to generate revenue through transaction fees when transacting the cryptocurrency. As an indirect effect of this, since a real estate that the licensed real estate agency intends to issue cryptocurrency will be a real estate where cryptocurrency transactions will be actively taking place in the future, and this proves that the real estate has good market forecasts, a real estate that will be favorable in the future will be more actively guided even to the real estate transactor, so that there is an effect that more reliable transactions may be induced between the real estate transactor and the licensed real estate agency.

FIG. 5 is an exemplary diagram of a smart contract block and a cryptocurrency transaction block in a cryptocurrency transaction system. A common public key number is indicated to search for an identification number for each real estate, a real estate unique attribute, and real estate transaction information, the market price is an amount per RFY unit of cryptocurrency, and the lowest selling price, the highest buying price, and the highest selling/buying order quantity and order price are also included to conclude a quick and reasonable transaction.

The cryptocurrency transaction block is generated by collecting transactions concluded within a certain period of time, and even if there is no conclusion within a certain period of time, a block is generated as illustrated in FIG. 5 and chained to the distributed ledger DB. The market price illustrated in FIG. 5 is a market price not for a building area or site area, but for cryptocurrency 1 RFY, indicating a current price based on 1,000,000 in Korean Won (KRW) per RFY at the time of issuance. In other words, 0.9 RFY indicates that 1,000,000 KRW at the time of issuance has fallen to the current 900,000 KRW, and 1.1 RFY indicates that the 1,000,000 KRW at the time of issuance has risen to a current 1,100,000 KRW. The unit of quantity of cryptocurrency is expressed in RFies. The name of the cryptocurrency (RFY in this example) is only an example, and the name thereof may be variously selected.

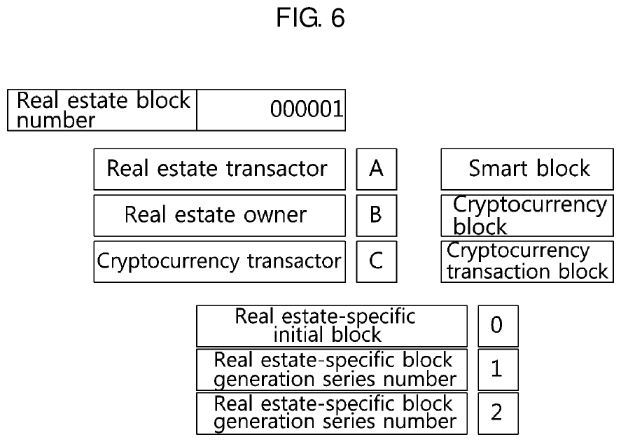

FIG. 6 is an example of an identification number for each block, wherein in the block identification number, a first number is an individual real estate number, a real estate transactor is classified as A, a real estate owner is classified as B, a cryptocurrency transaction is classified as C, and the cryptocurrency transaction between A and B is also classified as C. The number for each type of real estate may be subdivided and generated for each purpose, such as residential/non-residential/land/others, but will be omitted in this example, and classifications of A, B, C, etc. are only examples, and thus, may be displayed differently. In addition, all initial blocks are first blocks, and the unique number is 0. The identification number for each block as illustrated in FIG. 6 may be used for the initial block, the smart block, and the cryptocurrency block of FIG. 4, and the cryptocurrency transaction block of FIG. 5 may be used.

In addition, cryptocurrency exchange transactions may occur between cryptocurrency owners, and in this case, exceptionally, the method of the real estate transactor of FIG. 2 is processed. Since most of the cases have cryptocurrency, but have no transaction, if a reasonable exchange transaction is established through mutual valuation and intermediation of all participating licensed real estate agencies, the process of distributed issuance of transaction and generation of the smart block is performed.

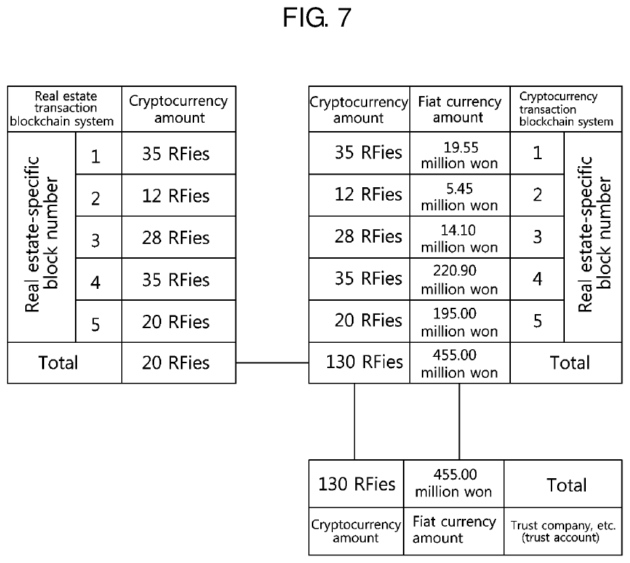

FIG. 7 illustrates that since the total amount of cryptocurrency which is marked in the name of the public key in each real estate address of the real estate transaction blockchain system of the present invention, and the total amount of cryptocurrency and the total amount of fiat currency which are marked in the name of the public key in each real estate address of the cryptocurrency transaction blockchain system are stored in a trust company, etc., the total amount of cryptocurrency and the total amount of fiat currency in the trust account are settled equally in real time.

When transacting the cryptocurrency or depositing and withdrawing the fiat currency, the private key of the cryptocurrency transactor is used, and the private key acts as an identification key indicated with the transaction history in the name of the public key linked to the private key at each address of the real estate transaction blockchain system when the transaction is made. If the real estate transactor or the cryptocurrency transactor transfers or remits cryptocurrency or fiat currency to an overseas account outside the network area of the system of the present invention, a membership certificate is required without using only a private key, and OTP, which is a separate one-time password, may be used, or in some cases, biometric security of Fast Identity On Time (FIPO) may be requested.

However, if each country may connect the platform of the blockchain system of the present invention, all areas and ranges may be grouped together to facilitate transfer or remittance using a private key to an address in the blockchain system of the present invention.

For the purpose of value transfer and settlement in the system of the present invention, a fry or korean dollar may be issued under the tentative name of a subordinate cryptocurrency of the RFY, and of course, the name may be issued differently. In this case, a blockchain-based personal wallet function may also be used.

As a tentative name to be used in the platform of the present invention, the fry or korean dollar is a stable coin and is used for purposes of having a monetary function such as purchasing cryptographic assets of RFY, remittance between members or non-members, and payment of other goods and services, and the issuance is first issued unsecured by trust, but has a security capacity by exchange with the legal currency of the stable coin user in each country. In addition, the stable coin is borrowed and refunded according to certain requirements according to the collateral value of the RFY, for example, KR-RFY in Korea, JN-RFY in Japan, and US-RFY in the US.

In principle, there is no limit to the issuance amount of the entire stable coin, but in order to optimize the stability of a platform ecosystem of the present invention, a required circulation amount is adjusted in the form of incineration or disposal. The ratio of the amount of stable coins used for the purchase of RFY crypto assets of each country and the amount of other stable coins used in others will be adjusted flexibly, such as 6:4, 7:3, 8:2, 9:1, etc. The entire process of issuing and distributing stable coins that are commonly used with the same value between countries may be implemented based on the platform of the present invention.

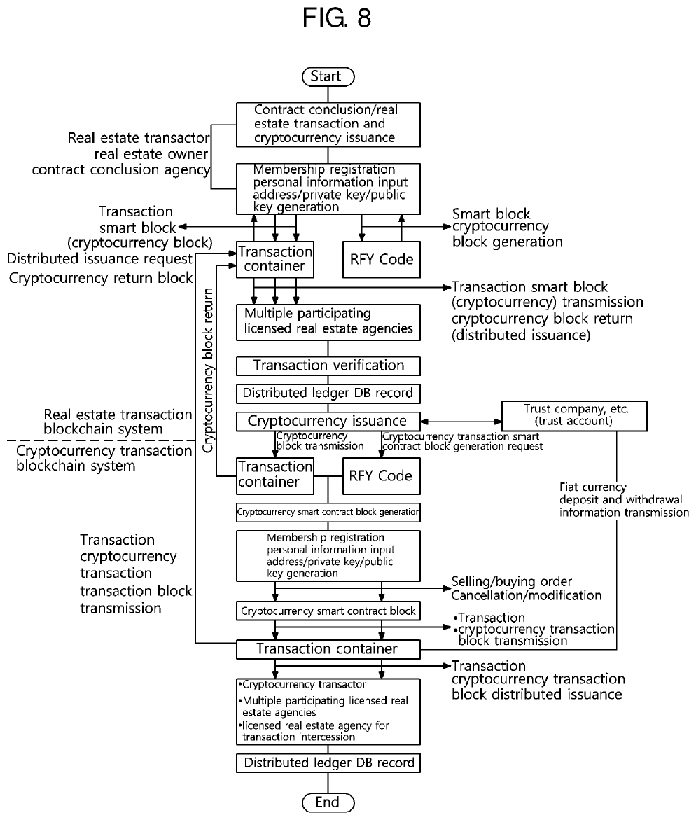

FIG. 8 is a flowchart illustrating an operation of the blockchain system between participants of the present invention, which summarizes the details described above as a flowchart. When operating and maintaining the system and network of the present invention, as a cryptocurrency issuer, a cryptocurrency transactor, and a market maker, a licensed real estate agency group, a trust company, and the like will participate together. As an operator of the system of the present invention, a separate company may perform the role thereof, or a trust company, an offline bank, an Internet bank, etc. may also perform the role thereof.

Hereinabove, the present invention has been described with reference to the embodiments, but it will be able to be easily appreciated by those skilled in the art that various modifications and changes of the present invention can be made without departing from the spirit and the scope of the present invention which are defined in the appended claims and their equivalents.

1. A real estate transaction and cryptocurrency transaction system using a blockchain technology, comprising:
a real estate transactor terminal, a real estate owner terminal, a licensed real estate agency terminal, a real estate transaction blockchain super node, a cryptocurrency transaction blockchain super node, which are connected to each other via a communication network,
wherein the real estate transaction blockchain super node intermediates the issuance of cryptocurrency for the requested real estate according to a request of any one of the real estate transactor terminal, the real estate owner terminal, and the licensed real estate agency terminal, and
the cryptocurrency transaction blockchain super node intermediates the cryptocurrency transaction issued for the requested real estate.

2. The real estate transaction and cryptocurrency transaction system of claim 1, wherein the real estate transaction blockchain super node transmits unique attribute information of a real estate for which cryptocurrency is issued and real estate transaction information to the cryptocurrency transaction blockchain super node, and the cryptocurrency transaction blockchain super node transmits cryptocurrency transaction information about the real estate for which the cryptocurrency is issued, thereby enabling the two systems to mutually share the related information in real time and to be integrally synchronized.

3. The real estate transaction and cryptocurrency transaction system of claim 2, wherein when a multi-signature transaction related to a real estate transaction for which a multi-signature by a seller and a buyer of a real estate to be transacted is completed is received from the real estate transactor terminal, or when a single-signature transaction related to a real estate for which a single signature by a real estate owner is completed is received from the real estate owner terminal, the real estate transaction blockchain super node distributes and issues the multi-signature transaction or the single-signature transaction to each participating licensed real estate agency terminal registered as the membership in the real estate transaction blockchain super node through a transaction container, and
when there is a request for the generation of a smart contract block for the real estate transaction or a cryptocurrency issuance block for the real estate from a licensed real estate agency terminal for contract conclusion that is involved in concluding a contract of a real estate transaction, the smart contract block or the cryptocurrency issuance block is generated to be distributed and issued to each participating licensed real estate agency terminal through the transaction container.

4. The real estate transaction and cryptocurrency transaction system of claim 3, wherein when the verification according to a cross-comparison between the smart contract blocks corresponding to the multi-signature transaction and the single signature transaction, and the cryptocurrency issuance block is completed through each participating licensed real estate agency terminal, the smart contract block and the cryptocurrency issuance block are blockchained to a distributed ledger DB and at the same time, the transaction lapses.

5. The real estate transaction and cryptocurrency transaction system of claim 4, wherein when a transaction is made on the cryptocurrency of the real estate for which the cryptocurrency is issued, the cryptocurrency transaction blockchain super node transmits a cryptocurrency transaction related transaction and a cryptocurrency transaction block generated by the cryptocurrency transaction related transaction to the real estate transaction blockchain super node, and distributes and issues the cryptocurrency transaction related transaction and the cryptocurrency transaction block to a cryptocurrency transactor terminal, a licensed real estate agency terminal for contract intercession for interceding the cryptocurrency transaction, and the each participating licensed real estate agency terminal through the transaction container.

6. The real estate transaction and cryptocurrency transaction system of claim 5, wherein when the verification according to a cross-comparison between the cryptocurrency transaction related transaction and the cryptocurrency transaction block is completed through each terminal distributed and issued with the cryptocurrency transaction related transaction and the cryptocurrency transaction block, the cryptocurrency transaction block is blockchained to the distributed ledger DB and at the same time, the transaction lapses.

7. The real estate transaction and cryptocurrency transaction system of claim 6, wherein the blockchaining to the distributed ledger DB according to the verification of the cross-comparison between the distributed and issued transaction and the blockchain block corresponding thereto is performed in a No-Objection state which satisfies that a state in which there is no objection for the distributed and issued transaction has elapsed for a predetermined time or more.

8. The real estate transaction and cryptocurrency transaction system of claim 7, wherein when the licensed real estate agency participates in the cryptocurrency issuance, the corresponding cryptocurrency issuance is regarded as mining and a certain ratio of amount of a cryptocurrency transaction fee is compensated to the participating licensed real estate agency whenever a transaction is made on the corresponding cryptocurrency.
